(19) United States
(12) Patent Application Publication
(10) Pub. No.: US 2024/0291366 A1
(43) Pub. Date: Aug. 29, 2024

(54) ACTUATOR AND ASSEMBLY METHOD THEREOF

(71) Applicant: NIDEC INSTRUMENTS CORPORATION, Nagano (JP)

(72) Inventor: Shogo TANAKA, Nagano (JP)

(21) Appl. No.: 18/586,545

(22) Filed: Feb. 26, 2024

(30) Foreign Application Priority Data
Feb. 28, 2023 (JP) 2023-029670

(51) Int. Cl. H02K 33/18; H02K 15/00

(52) U.S. Cl. CPC H02K 33/18; H02K 15/00

(57) ABSTRACT

An actuator includes a support body having a coil holder, a movable body having one side magnet facing a coil on one side, the other side magnet facing the coil on the other side, and a yoke to which the one side magnet and the other side magnet are fixed, and a connection body which relatively movably connects the support body and the movable body. The yoke is formed of one yoke member which is formed with a first yoke portion, a second yoke portion fixed with the one side magnet, a third yoke portion, a fourth yoke portion fixed with the other side magnet by bending the one yoke member so as to surround the coil. The yoke is formed of one yoke member and thus, an end portion of the fourth yoke portion and an end portion of the first yoke portion are fixed to each other.

### CROSS REFERENCE TO RELATED APPLICATION

The present invention claims priority under 35 U.S.C. § 119 to Japanese Application No. 2023-029670 filed Feb. 28, 2023, the entire content of which is incorporated herein by reference.

### TECHNICAL FIELD

At least an embodiment of the present invention may relate to an actuator structured to move a movable body by a magnetic drive mechanism having a coil and a magnet.

### BACKGROUND

As a device for notifying information by vibration, an actuator has been known which is structured to vibrate a movable body supported in a support body by a magnetic drive mechanism. An actuator described in Japanese Patent Laid-Open No. 2019-013094 (Patent Literature 1) includes a support body having a coil, a movable body having a magnet and a yoke, and a connection body which relatively movably connect the movable body with the support body. The magnet of the movable body faces a winding part of the coil. The magnetic drive mechanism relatively moves the movable body and the support body in a direction perpendicular to a facing direction where the coil and the magnet face each other.

In the actuator described in Patent Literature 1, in a case that three directions perpendicular to each other are defined as a first axis direction, a second axis direction and a third axis direction, and a facing direction in which the coil and the magnet face each other is the first axis direction, and a relatively moving direction of the movable body and the support body is the second axis direction, the actuator includes, as the magnet, a plurality of first magnets which face the coil on one side in the first axis direction and a plurality of second magnets which face the coil on the other side in the first axis direction. The yoke is structured of two members, i.e., a first yoke member which holds a plurality of the first magnets and a second yoke member which holds a plurality of the second magnets.

The first yoke member is provided with a yoke portion which is extended in the second axis direction on one side in the first axis direction with respect to the coil, a first connecting plate part which is extended in the first axis direction on one side in the second axis direction with respect to the coil, and a second connecting plate part which is extended in the first axis direction on the other side in the second axis direction with respect to the coil. A first bent portion is provided between the yoke portion and the first connecting plate part, and a second bent part is provided between the yoke portion and the second connecting plate part. A plurality of the first magnets is fixed to the yoke portion. On the other hand, the second yoke member is formed in a flat plate shape. The second yoke member is extended in the second axis direction on the other side in the first axis direction with respect to the coil, and a plurality of the second magnets is fixed to its face facing the coil. One end portion in the second axis direction of the second yoke member is fixed to an end part of the first connecting plate part of the first yoke member on an opposite side to the first bent portion by welding. The other end portion in the second axis direction of the second yoke member is fixed to an end part of the second connecting plate part of the first yoke member on an opposite side to the second bent part by welding.

In the above-mentioned literature, when the actuator is viewed in the third axis direction, the yoke surrounds the coil. Therefore, magnetic flux from the first magnets and magnetic flux from the second magnets flow so as to surround the coil in accordance with a shape of the yoke. As a result, the magnetic flux from the magnets can be inhibited from leaking outside the yoke and thus, the magnetic drive mechanism easily ensures thrust for relatively moving the support body and the movable body.

The yoke of the above-mentioned actuator is structured of two members. Therefore, it is easy that a magnet fixed to the yoke is located on one side and the other side with respect to a coil, and the coil is surrounded by the yoke. However, the yoke is structured of two members and thus, in comparison with a case that the yoke is structured of one member, the number of components increases. Further, in the above-mentioned actuator, a fixing part where the first yoke member and the second yoke member are fixed is provided at two positions in the second axis direction. Therefore, when the yoke is to be assembled, fixing work such as welding or caulking is required to perform at two positions.

### SUMMARY

In view of the problem described above, at least an embodiment of the present invention may advantageously provide an actuator and its assembly method in which a yoke is structured of one member and fastening work when a coil is surrounded by the yoke is performed at only one position.

According to at least an embodiment of the present invention, there may be provided an actuator including, in a case that two directions perpendicular to each other are defined as a first axis direction and a second axis direction, a support body including a coil whose opening is directed in the first axis direction, a coil holder having a coil holding part which holds the coil, a first support member which supports the coil holder from one side in the first axis direction, and a second support member which supports the coil holder from the other side in the first axis direction, a movable body including one side magnet which faces the coil on one side in the first axis direction, the other side magnet which faces the coil on the other side in the first axis direction, and a yoke to which the one side magnet and the other side magnet are fixed, a connection body which relatively movably connects the first support member and the movable body in the second axis direction between the first support member and the movable body, and a magnetic drive mechanism including the one side magnet, the other side magnet and the coil and relatively moving the movable body and the support body in the second axis direction. The yoke is provided with a first yoke portion which is extended in the first axis direction on one side in the second axis direction with respect to the coil holding part, a second yoke portion which is extended in the second axis direction on one side in the first axis direction with respect to the coil holding part and is fixed with the one side magnet, a third yoke portion which is extended in the first axis direction on the other side in the second axis direction with respect to the coil holding part, a fourth yoke portion which is extended in the second axis direction on the other side in the first axis direction with respect to the coil holding part and is fixed with the other side magnet, a first bent portion which continuously connects the first yoke portion with the second yoke portion, a second bent portion which continuously connects the second yoke portion with the third yoke portion, a third bent portion which continuously connects the third yoke portion with the fourth yoke portion, and a fixed part in which an end portion on one side in the second axis direction of the fourth yoke portion and an end portion on the other side in the first axis direction of the first yoke portion are fixed to each other. The one side magnet is polarized and magnetized in the second axis direction, and the other side magnet is polarized and magnetized in the second axis direction, and the one side magnet and the other side magnet are disposed so that different poles face each other with the coil interposed therebetween.

In the actuator in accordance with at least an embodiment of the present invention, the yoke which surrounds the coil holding part holding a coil is one member provided with three bent parts and one fixed part. Therefore, in comparison with a case that a yoke is structured of two yoke members which are combined with each other, a number of the components can be reduced. Further, fastening work when a yoke is to be assembled is simply performed on only one fixed part. Therefore, in comparison with a case that fastening work is performed on a plurality of fixed parts, fastening work can be reduced.

In at least an embodiment of the present invention, the fixed part may be provided with a welded mark. In other words, the first yoke portion and the fourth yoke portion of the yoke may be fixed to each other by welding.

In at least an embodiment of the present invention, the fixed part may be provided with a caulking mark. In other words, the first yoke portion and the fourth yoke portion of the yoke may be fixed to each other by calking.

In at least an embodiment of the present invention, it may be structured that the coil holder is provided with an opening part which penetrates in the first axis direction on the other side in the second axis direction with respect to the coil holding part, the third yoke portion penetrates through the opening part, thicknesses of the third yoke portion and the fourth yoke portion are the same as each other, and a width dimension in the second axis direction of the opening part is larger than a total dimension of a yoke thickness dimension of the fourth yoke portion and a magnet thickness dimension of the other side magnet. According to this structure, the third yoke portion can be arranged at a position close to the coil holding part. Therefore, the yoke is capable of surrounding the coil at a position close to the coil. Further, when a width dimension in the second axis direction of the opening part through which the third yoke portion is penetrated in the first axis direction is set to be larger than a total dimension of a first thickness dimension of the fourth yoke portion and a second thickness dimension of the other side magnet, a moving distance of the movable body moving in the second axis direction can be easily secured.

In at least an embodiment of the present invention, it may be structured that the support body includes, as the coil, a first coil and a second coil which is disposed on the other side in the second axis direction with respect to the first coil, the movable body includes, as the one side magnet, a first magnet facing the first coil and a second magnet which faces the second coil on the other side in the second axis direction with respect to the first magnet and, as the other side magnet, a third magnet facing the second coil and a fourth magnet which faces the first coil on one side in the second axis direction with respect to the third magnet, the first magnet and the fourth magnet are disposed so that different poles face each other with the first coil interposed therebetween, and the third magnet and the second magnet are disposed so that different poles face each other with the second coil interposed therebetween. According to this structure, a plurality of a pair of a magnetic drive circuit is provided which is structured of the coil, the one side magnet and the other side magnet. Therefore, thrust of the magnetic drive mechanism by which the movable body and the support body are relatively moved can be easily increased.

Next, according to at least an embodiment of the present invention, there may be provided an assembly method of the actuator described above, including a magnet fixing step in which the one side magnet is fixed to a first fixing position which is set on one face of a yoke member formed in a flat plate shape, and the other side magnet is fixed to a second fixing position which is set on the other side in the second axis direction with respect to the first fixing position, a yoke preparation step in which the yoke member is bent on one side in the second axis direction with respect to the first fixing position where the one side magnet is fixed to form the first bent portion and the first yoke portion in the yoke member, and the yoke member is bent on the other side in the second axis direction with respect to the first fixing position to form in the yoke member with the second bent portion, the second yoke portion and an extended yoke portion which is structured of the third yoke portion and the fourth yoke portion which are continuously extended in a straight shape in the first axis direction, a yoke arrangement step in which the first bent portion, the second yoke portion and the second bent portion are disposed on one side in the first axis direction with respect to the coil holding part and thereby, the first yoke portion is located on one side in the second axis direction with respect to the coil holding part, and the extended yoke portion is located on the other side in the second axis direction with respect to the coil holding part, a yoke bending step in which the extended yoke portion is bent on the other side in the first axis direction with respect to the coil holding part between the second fixing position where the other side magnet is fixed and the second bent portion to form the third yoke portion, the third bent portion and the fourth yoke portion in the yoke member, and the fourth yoke portion is extended in the second axis direction, and a fixed part forming step in which an end portion on one side in the second axis direction of the fourth yoke portion and an end portion on the other side in the first axis direction of the first yoke portion are fixed to each other.

According to the assembly method of the actuator in at least an embodiment of a present invention, first, one side magnet and the other side magnet are fixed to one face of the yoke member in a flat plate shape. Next, the yoke member is bent twice to form the first bent portion, the second yoke portion, the second bent part and the extended yoke portion. After that, the first bent portion, the second yoke portion and the second bent portion are disposed on one side in the first axis direction with respect to the coil holding part, and the first yoke portion is located on one side in the second axis direction with respect to the coil holding part, and the extended yoke portion is located on the other side in the second direction with respect to the coil holding part. After that, the extended yoke portion is bent on the other side in the first direction with respect to the coil holding part to form the third yoke portion, the third bent portion and the fourth yoke portion, and the fourth yoke portion is extended in the second direction. After that, an end portion on one side in the second axis direction of the fourth yoke portion and an end portion on the other side in the first axis direction of the first yoke portion are fixed to each other. Therefore, the one side magnet and the other side magnet which are fixed to the yoke member in a flat plate shape are easily located on both sides in the first axis direction with respect to the coil. Further, the coil holding part which holds the coil is easily surrounded by the yoke.

In at least an embodiment of the present invention, in the fixed part forming step, the fourth yoke portion and the first yoke portion may be welded.

In at least an embodiment of the present invention, in the fixed part forming step, the fourth yoke portion and the first yoke portion may be caulked.

In at least an embodiment of the present invention, it may be structured that the coil holder is provided with an opening part penetrating in the first axis direction on the other side in the second axis direction with respect to the coil holding part and, in the yoke arrangement step, the extended yoke portion is penetrated through the opening part to locate the extended yoke portion on the other side in the second axis direction with respect to the coil holding part, and a width dimension of the opening part in the second axis direction is larger than a total dimension of a thickness dimension of the extended yoke portion and a thickness dimension of the other side magnet. According to this structure, the extended yoke portion can be inserted into the opening part.

In at least an embodiment of the present invention, it may be structured that, in the magnet fixing step, a magnet which is polarized and magnetized in the second axis direction is used as the one side magnet and the other side magnet, and magnets adjacent to each other in the second axis direction are arranged so that different poles face each other. According to this structure, a situation can be avoided that adjacent magnets arranged in the second axis direction repel each other to be difficult to fix to the yoke member. Further, according to this structure, when the yoke member is bent at the three bent parts, the one side magnet and the other side magnet are disposed so that different poles face each other with the coil interposed therebetween.

In at least an embodiment of the present invention, it may be structured that, in the actuator, the support body includes, as the coil, a first coil and a second coil which is disposed on the other side in the second axis direction with respect to the first coil, the movable body includes, as the one side magnet, a first magnet facing the first coil and a second magnet which faces the second coil on the other side in the second axis direction with respect to the first magnet and, as the other side magnet, a third magnet facing the second coil and a fourth magnet which faces the first coil on one side in the second axis direction with respect to of the third magnet, the first magnet and the fourth magnet are disposed so that different poles face each other with the first coil interposed therebetween, the second magnet and the third magnet are disposed so that different poles face each other with the second coil interposed therebetween and, in the magnet fixing step, a magnet which is polarized and magnetized in the second axis direction is used as the first magnet, the second magnet, the third magnet and the fourth magnet, and the first magnet, the second magnet, the third magnet and the fourth magnet are arranged from one side in the second axis direction toward the other side in the second axis direction in this order so that different poles face each other in magnets adjacent to each other in the second axis direction. According to this structure, a situation can be avoided that adjacent magnets arranged in the second axis direction repel each other and thereby, the magnets are difficult to be fixed to the yoke member. Further, when the yoke member is bent at the three bent parts, the first magnet and the fourth magnet are disposed so that different poles face each other with the first coil interposed therebetween, and the second magnet and the third magnet are disposed so that different poles face each other with the second coil interposed therebetween.

In at least an embodiment of the present invention, it may be structured that, in the magnet fixing step, an unmagnetized magnet is used as the one side magnet and the other side magnet, and a magnet magnetizing step is provided between the magnet fixing step and the yoke preparation step and, in the magnet magnetizing step, the one side magnet and the other side magnet are magnetized so that an “S”-pole and an “N”-pole are alternately arranged in the second axis direction. According to this structure, in comparison with a case that magnets arranged in the second axis direction are magnetized so that the same poles face each other, magnetizing work is easily performed. Further, when the yoke member is bent at the three bent parts, the one side magnet and the other side magnet are disposed so that different poles face each other with the coil interposed therebetween.

In at least an embodiment of the present invention, it may be structured that, in the actuator, the support body includes, as the coil, a first coil and a second coil which is disposed on the other side in the second axis direction with respect to the first coil, the movable body includes, as the one side magnet, a first magnet facing the first coil and a second magnet which faces the second coil on the other side in the second axis direction with respect to the first magnet and, as the other side magnet, a third magnet facing the second coil and a fourth magnet which faces the first coil on one side in the second axis direction with respect to the third magnet, the first magnet and the fourth magnet are disposed so that different poles face each other with the first coil interposed therebetween, the second magnet and the third magnet are disposed so that different poles face each other with the second coil interposed therebetween and, in the magnet fixing step, an unmagnetized magnet is used as the first magnet, the second magnet, the third magnet and the fourth magnet, and the first magnet, the second magnet, the third magnet and the fourth magnet are fixed to the yoke member from one side in the second axis direction toward the other side in this order, and a magnet magnetizing step is provided between the magnet fixing step and the yoke preparation step and, in the magnet magnetizing step, the first magnet, the second magnet, the third magnet and the fourth magnet are magnetized so that an “S”-pole and an “N”-pole are alternately arranged in the second axis direction. According to this structure, in comparison with a case that magnets arranged in the second axis direction are magnetized so that the same poles face each other, magnetizing work is easily performed. Further, when the yoke member is bent at the three bent parts, the first magnet and the fourth magnet are disposed so that different poles face each other with the first coil interposed therebetween, and the second magnet and the third magnet are disposed so that different poles face each other with the second coil interposed therebetween.

### Effects of the Invention

In the actuator in accordance with the present invention, the yoke which surrounds the coil holding part holding the coil is one member provided with three bent parts and one fixed part. Therefore, the number of the components can be reduced. Further, fastening work when the yoke is to be assembled is simply performed on only one fixed part. Therefore, in comparison with a case that fastening work is performed on a plurality of fixed parts, the actuator can be easily assembled.

Further, according to the assembly method of the actuator in the present invention, the coil holding part which holds the coil can be easily surrounded by the yoke which is formed by bending one yoke member. Further, the one side magnet and the other side magnet can be easily arranged on both sides with respect to the coil by using the yoke member.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is an outward perspective view showing an actuator in accordance with an embodiment of the present invention.

FIG. 2 is the “X-Z” cross-sectional view (“A-A” cross-sectional view in FIG. 4) showing the actuator in FIG. 1.

FIG. 3 is the “Y-Z” cross-sectional view (“B-B” cross-sectional view in FIG. 4) showing the actuator in FIG. 1.

FIG. 4 is the “X-Y” cross-sectional view (“C-C” cross-sectional view in FIG. 2) showing the actuator in FIG. 1.

FIG. 5 is an exploded perspective view showing the actuator in FIG. 1.

FIG. 6 is a flow chart showing an assembly method of the actuator.

FIG. 7 is an explanatory view showing a magnet fixing step and a magnet magnetizing step.

FIG. 8 is an explanatory view showing a yoke preparation step.

FIG. 9 is an explanatory view showing a yoke arrangement step.

FIG. 10 is an explanatory view showing a yoke bending step and a fixing part forming step.

### DETAILED DESCRIPTION

An actuator 1 in accordance with an embodiment of the present invention will be described below with reference to the accompanying drawings.

An actuator 1 is used as a tactile device which is, for example, incorporated into an operation member of a game machine, an operation panel, a steering wheel of an automobile, a chair or the like. The actuator 1 vibrates a movable body 3 by a magnetic drive mechanism 4 having a coil 6 and a magnet 7 to give a tactile sense to a user by the vibration. In the following descriptions, directions along three axes perpendicular to each other are respectively defined as a “Z”-axis direction (first axis direction), an “X”-axis direction (second axis direction), and a “Y”-axis direction (third axial direction). Further, one side in the “X”-axis direction is defined as an “X1” direction side, the other side is defined as an “X2” direction, one side in the “Z”-axis is defined as a “Z1” direction, and the other side is defined as a “Z2” direction.

### (Entire Structure)

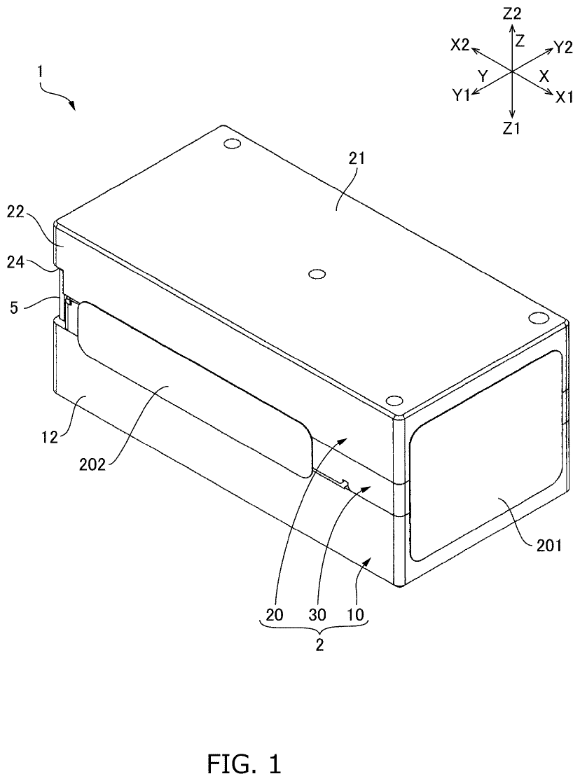

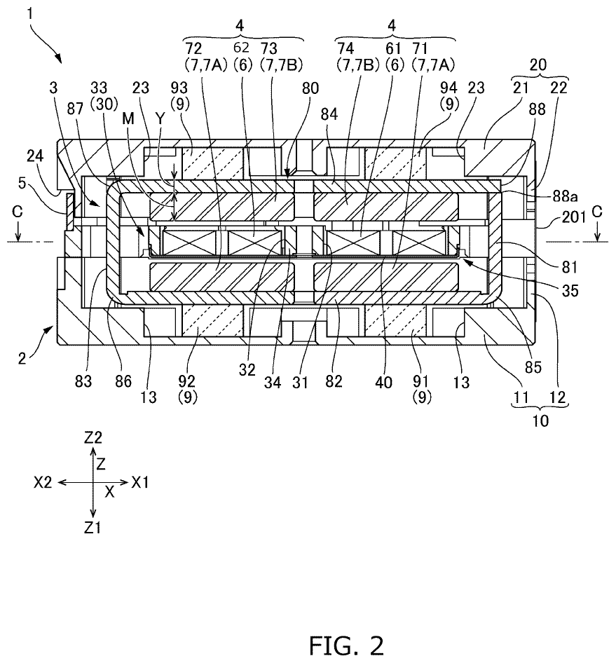

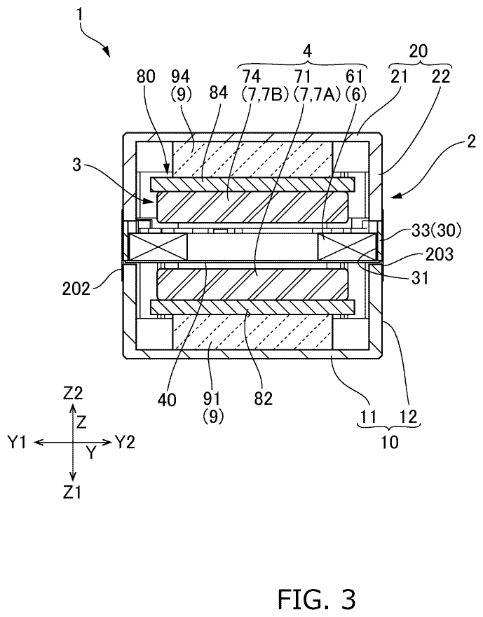

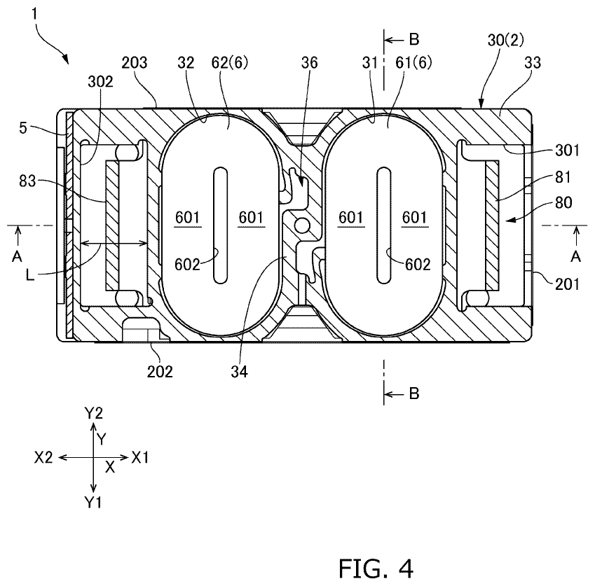

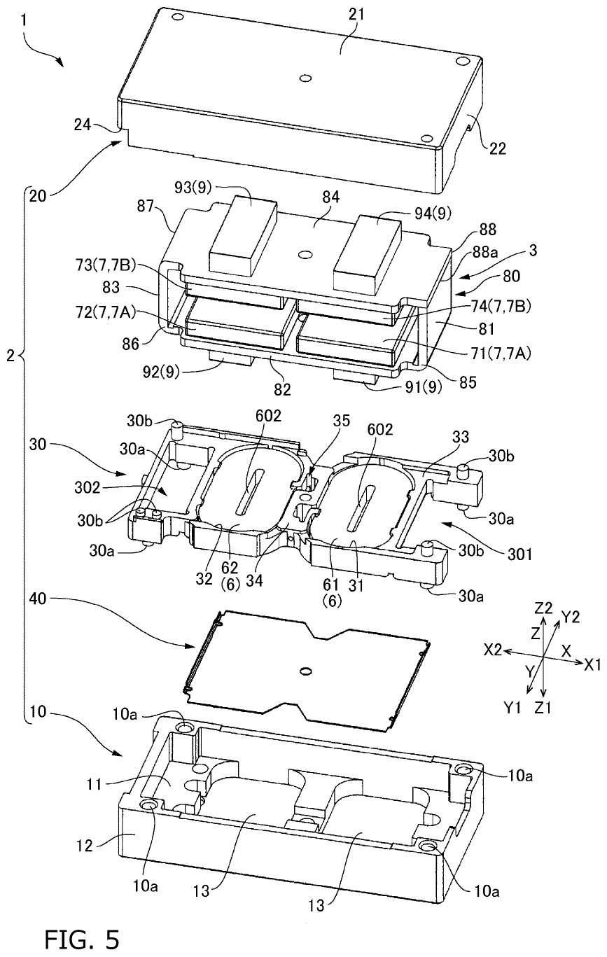

FIG. 1 is a perspective view showing an actuator 1 in accordance with an embodiment of the present invention. FIG. 2 is the “X-Z” cross-sectional view showing the actuator 1 in FIG. 1 and a cross-sectional view showing the actuator 1 which is cut at the “A-A” position in FIG. 4. FIG. 3 is the “Y-Z” cross-sectional view showing the actuator 1 in FIG. 1 and a cross-sectional view showing the actuator 1 which is cut at the “B-B” position in FIG. 4. FIG. 4 is the “X-Y” cross-sectional view showing the actuator 1 in FIG. 1 and a cross-sectional view showing the actuator 1 which is cut at the “C-C” position in FIG. 2. FIG. 5 is an exploded perspective view showing the actuator 1 in FIG. 1.

As shown in FIG. 1, the actuator 1 is a rectangular parallelepiped shape whose dimension in the second axis direction “X” is larger than a dimension in the third axial direction “Y” and a dimension in the “Z”-axis direction. As shown in FIGS. 2 through 5, the actuator 1 includes a support body 2, a movable body 3 and a connection body 9 which relatively movably connects the support body 2 and the movable body 3 in the “X”-axis direction. A coil 6 is held by the support body 2. A magnet 7 is held by the movable body 3. The coil 6 and the magnet 7 face each other in the “Z”-axis direction, and a magnetic drive mechanism 4 relatively moves the support body 2 and the movable body 3 in the “X”-axis direction. The connection body 9 is a gel state member (viscoelastic body). A wiring circuit board 5 is fixed to an outer peripheral face of the support body 2. An electric current is supplied to the coil 6 through the wiring circuit board 5.

### (Support Body)

The support body 2 includes the coil 6 and a coil holder 30 which holds the coil 6. As shown in FIGS. 2, 3 and 5, a metal plate 40 is overlapped on the “Z1” direction side of the coil holder 30. Further, the support body 2 includes a first support member 10 which supports the coil holder 30 from the “Z1” direction side, and a second support member 20 which supports the coil holder 30 from the “Z2” direction side. Therefore, the first support member 10, the coil holder 30 and the second support member 20 are overlapped in this order from the “Z1” direction side toward the “Z2” direction side. The movable body 3 is located between the first support member 10 and the second support member 20.

As shown in FIGS. 2 and 5, the first support member 10 is provided with a first end plate part 11 having two recessed parts 13 disposed side by side in the “X”-axis direction, and a first side plate part 12 extended to the “Z2” direction side from an outer peripheral edge of the first end plate part 11. As shown in FIG. 5, a contour shape of the first end plate part 11 is a rectangular shape which is long in the “X”-axis direction, and the first side plate part 12 is a rectangular frame shape. As shown in FIG. 2, the second support member 20 is provided with a second end plate part 21 having two recessed parts 23 disposed side by side in the “X”-axis direction, and a second side plate part 22 which is extended to the “Z1” direction side from an outer peripheral edge of the second end plate part 21. As shown in FIG. 5, each of tip end faces of four corner parts of the first side plate part 12 is provided with a hole 10a. Further, each of tip end faces of four corner parts of the second side plate part 22 is also provided with a hole (not shown).

The coil holder 30 is provided with a plate part 33 which is parallel to the “X-Y” plane. A center portion in the “X”-axis direction of the plate part 33 is provided with a first coil arrangement hole 31 and a second coil arrangement hole 32 which penetrate through the plate part 33 in the “Z”-axis direction. The first coil arrangement hole 31 and the second coil arrangement hole 32 are arranged in the “X”-axis direction, and the first coil arrangement hole 31 is located on the “X1” direction side with respect to the second coil arrangement hole 32. A partition part 34 extended in the third axial direction “Y” is provided between the first coil arrangement hole 31 and the second coil arrangement hole 32 in the “X”-axis direction. The partition part 34 is located at a substantially center in the “X”-axis direction of the coil holder 30.

A cut-out part 301 is provided in the plate part 33 on the “X1” direction side with respect to the first coil arrangement hole 31. An opening part 302 is provided in the plate part 33 on the “X2” direction side with respect to the second coil arrangement hole 32. The cut-out part 301 and the opening part 302 penetrate through the plate part 33 in the “Z”-axis direction. In the plate part 33, a portion between the cut-out part 301 and the opening part 302 in the “X”-axis direction, in other words, a portion where the first coil arrangement hole 31 and the second coil arrangement hole 32 are provided is a coil holding part 35. A width dimension “L” (see FIG. 4) in the “X”-axis direction of the opening part 302 is larger than a total dimension of a yoke thickness dimension “Y” (see FIG. 2) of a yoke member 100 described below and a thickness dimension “M” of the other side magnet 7B (see FIG. 2).

As shown in FIG. 5, each of four corner parts of an outer periphery of the coil holder 30 is provided with a protruded part 30a protruded to the first support member 10 side and a protruded part 30b protruded to the second support member 20 side. When the support body 2 is to be assembled, the protruded part 30a of the coil holder 30 is fitted to the hole 10a of the first support member 10, and the protruded part 30b of the coil holder 30 is fitted to the hole (not shown) of the second support member 20. Therefore, the first support member 10, the coil holder 30 and the second support member 20 are connected with each other in a positioned state. The first support member 10, the coil holder 30 and the second support member 20 are, for example, coupled to each other by an adhesive.

As shown in FIGS. 1 and 4, a wiring circuit board 5 is fixed to a side face on the “X2” direction side of the coil holder 30. As shown in FIG. 2, a side face on the “X2” direction side of the second support member 20 is formed with a recessed part 24 in which an upper end portion of the wiring circuit board 5 protruded to the “Z2” direction side from the coil holder 30 is arranged. A coil wire (not shown) extended from the coil 6 is routed along a face on the “Z2” direction side of the coil holder 30 and is connected with the wiring circuit board 5.

The plate 40 is overlapped with the first coil arrangement hole 31 and the second coil arrangement hole 32 on the “Z1” direction side of the coil holder 30, but is not overlapped with the cut-out part 301 and the opening part 302. When the coil 6 is to be fixed to the coil holder 30, the plate 40 and the coil holder 30 are laminated and then, the coil 6 is arranged in the first coil arrangement hole 31 and the second coil arrangement hole 32 where an adhesive has been applied and thereby, the coil 6 is fixed.

As shown in FIG. 1, an outer peripheral face on the “X1” direction side of the actuator 1 which is formed by laminating the first support member 10, the coil holder 30 and the second support member 20 is stuck with a seal member 201 which closes the cut-out part 301 of the coil holder 30. Further, a seal member 202 is stuck on an outer peripheral face on the “Y1” direction side of the actuator 1 and a seal member 203 is stuck on an outer peripheral face on its “Y2” direction side (see FIG. 4).

As shown in FIGS. 2, 4 and 5, in this embodiment, the support body 2 includes a first coil 61 and a second coil 62 as the coil 6. The first coil 61 is disposed in the first coil arrangement hole 31. The second coil 62 is disposed in the second coil arrangement hole 32. Therefore, the first coil 61 is located on the “X1” direction side with respect to the second coil 62. The coil 6 is an air core coil in an elliptical shape having two effective sides 601 which are extended in the third axial direction “Y”. As shown in FIG. 5, an opening 602 of the coil 6 (first coil 61 and second coil 62) is directed in the “Z”-axis direction. The first coil 61 and the second coil 62 are the same coil as each other.

### (Movable Body)

As shown in FIG. 5, the movable body 3 includes a magnet 7 and a yoke 80 to which the magnet 7 is fixed. In this embodiment, as shown in FIG. 2, the movable body 3 includes, as the magnet 7, one side magnet 7A facing the coil 6 on the “Z1” direction side with respect to the coil 6, and the other side magnet 7B facing the coil 6 on the “Z2” direction side with respect to the coil 6. Further, the one side magnet 7A includes a first magnet 71 which faces effective sides 601 of the first coil 61 from the “Z1” direction side, and a second magnet 72 which faces effective sides 601 of the second coil 62 from the “Z1” direction side. The other side magnet 7B includes a third magnet 73 which faces the effective sides 601 of the second coil 62 from the “Z2” direction side, and a fourth magnet 74 which faces the effective sides 601 of the first coil 61 from the “Z2” direction side. The first magnet 71 is located on the “X1” direction side with respect to the second magnet 72. The fourth magnet 74 is located on the “X1” direction side with respect to the third magnet 73.

As shown in FIG. 2, the yoke 80 surrounds the coil holding part 35 of the coil holder 30 when viewed in the “Y”-axis direction. In other words, the yoke 80 is provided with a first yoke portion 81 which is extended in the “Z”-axis direction on the “X1” direction side with respect to the coil holding part 35, a second yoke portion 82 which is extended in the “X”-axis direction on the “Z1” direction side with respect to the coil holding part 35, a third yoke portion 83 which is extended in the “Z”-axis direction on the “X2” direction side with respect to the coil holding part 35, and a fourth yoke portion 84 which is extended in the “X”-axis direction on the “Z2” direction side with respect to the coil holding part 35. Further, the yoke 80 is provided with a first bent portion 85 which continuously connects the first yoke portion 81 with the second yoke portion 82, a second bent portion 86 which continuously connects the second yoke portion 82 with the third yoke portion 83, a third bent portion 87 which continuously connects the third yoke portion 83 with the fourth yoke portion 84, and a fixed part 88 in which an end portion on the “X1” direction side of the fourth yoke portion 84 and an end portion on the “Z2” direction side of the first yoke portion 81 are fixed to each other. The fixed part 88 is provided with a welded mark 88a. In other words, the end portion on the “X1” direction side of the fourth yoke portion 84 and the end portion on the “Z2” direction side of the first yoke portion 81 are connected with each other by welding. As described below, the yoke 80 is structured of one yoke member in a flat plate shape having a predetermined thickness which is formed so as to surround the coil holding part 35 by providing three bent portions 85, 86 and 87 and one fixed part 88. Therefore, thickness dimensions (yoke thickness dimension “Y”) of the first yoke portion 81, the second yoke portion 82, the third yoke portion 83 and the fourth yoke portion 84 are the same as each other.

The second yoke portion 82 is fixed with the one side magnet 7A (first magnet 71 and second magnet 72). The fourth yoke portion 84 is fixed with the other side magnet 7B (third magnet 73 and fourth magnet 74). The first magnet 71, the second magnet 72, the third magnet 73 and the fourth magnet 74 are respectively fixed to the yoke 80 by a method such as adhesion.

In this embodiment, each of the one side magnet 7A and the other side magnet 7B is polarized and magnetized in the “X”-axis direction. In other words, each of the first magnet 71, the second magnet 72, the third magnet 73 and the fourth magnet 74 is polarized and magnetized in the “X”-axis direction. Further, the first magnet 71 and the second magnet 72 are disposed so that different poles face each other in the “X”-axis direction. The third magnet 73 and the fourth magnet 74 are disposed so that different poles face each other in the “X”-axis direction. In addition, the first magnet 71 fixed to the second yoke portion 82 and the fourth magnet 74 fixed to the fourth yoke portion 84 are disposed so that different poles face each other with the first coil 61 interposed therebetween in the “Z”-axis direction. Further, the second magnet 72 fixed to the second yoke portion 82 and the third magnet 73 fixed to the fourth yoke portion 84 are disposed so that different poles face each other with the second coil 62 interposed therebetween in the “Z”-axis direction.

The one side magnet 7A fixed to the yoke 80 (first magnet 71 and second magnet 72) and the other side magnet 7B (third magnet 73 and fourth magnet 74) structure the magnetic drive mechanism 4 together with the first coil 61 and the second coil 62 which are held by the support body 2.

### (Connection Body)

As shown in FIG. 2, the connection body 9 is disposed at a position where the support body 2 and the movable body 3 face each other in the “Z”-axis direction. The movable body 3 is movably supported by the connection body 9 in the “X”-axis direction. In this embodiment, the connection body 9 is provided with a first connection body 91 and a second connection body 92 which are disposed between the movable body 3 and the first support member 10. The first connection body 91 and the second connection body 92 are arranged with a space therebetween in the “X”-axis direction. Further, the connection body 9 is provided with a third connection body 93 and a fourth connection body 94 which are disposed between the movable body 3 and the second support member 20. The third connection body 93 and the fourth connection body 92 are arranged with a space therebetween in the “X”-axis direction. The first connection body 91 and the second connection body 92 are set in a compressed state in the “Z”-axis direction between the second yoke portion 82 of the yoke 80 and bottom faces of the recessed parts 13 of the first support member 10. The third connection body 93 and the fourth connection body 94 are set in a compressed state in the “Z”-axis direction between the fourth yoke portion 84 and bottom faces of the recessed parts 23 of the second support member 20.

The connection body 9 is provided with at least one of elasticity and viscoelasticity. In this embodiment, the connection body 9 is a viscoelastic body. The connection body 9 (viscoelastic body) is silicone-based gel whose penetration degree is from 10 to 110 degrees. The penetration degree is prescribed in JIS-K-2207 and JIS-K-2220, and the smaller the value is, the hardness is larger. Further, as the connection body 9 provided with viscoelasticity, the following material may be used. In other words, various rubber materials such as natural rubber, diene-based rubber (for example, styrene butadiene rubber, isoprene rubber, butadiene rubber, chloroprene rubber and acrylonitrile butadiene rubber), non-diene-based rubber (for example, butyl rubber, ethylene propylene rubber, ethylene propylene diene rubber, urethane rubber, silicone rubber and fluorine-containing rubber) and thermoplastic elastomer, and their denatured materials.

The connection body 9 is provided with linear or non-linear expansion and contraction characteristics according to its expansion and contraction direction. For example, the connection body 9 is provided with expansion and contraction characteristics whose non-linear component (spring coefficient) is larger than a linear component (spring coefficient) when it is pressed in its thickness direction (axial direction) to be compressed and deformed. On the other hand, the connection body 9 is provided with expansion and contraction characteristics whose linear component (spring coefficient) is larger than a non-linear component (spring coefficient) when it is pulled and extended in its thickness direction (axial direction). Further, in a case that the connection body 9 is deformed in a direction intersecting its thickness direction (axial direction), i.e., in its shearing direction, even when it is moved in either direction, the connection body 9 is deformed in a direction where the connection body 9 is pulled and extended. Therefore, the connection body 9 is provided with deformation characteristics whose linear component (spring coefficient) is larger than a non-linear component (spring coefficient).

When the movable body 3 is vibrated in the “X”-axis direction, the connection body 9 is deformed in a shearing direction. Therefore, the connection body 9 uses a spring factor in the shearing direction when the movable body 3 is vibrated in the “X”-axis direction and thus, reproducibility of vibrational acceleration to an input signal can be improved and vibration with a delicate nuance can be realized.

### (Assembly Method of Actuator 1)

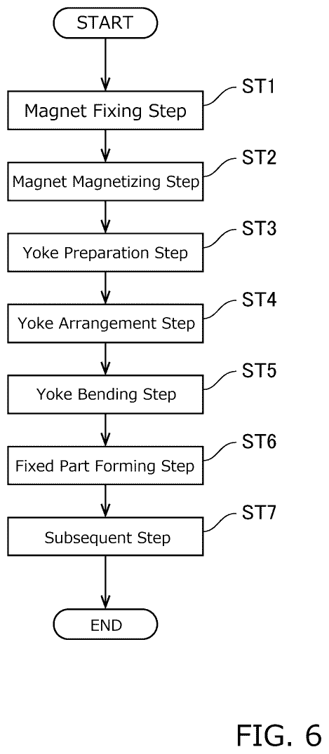

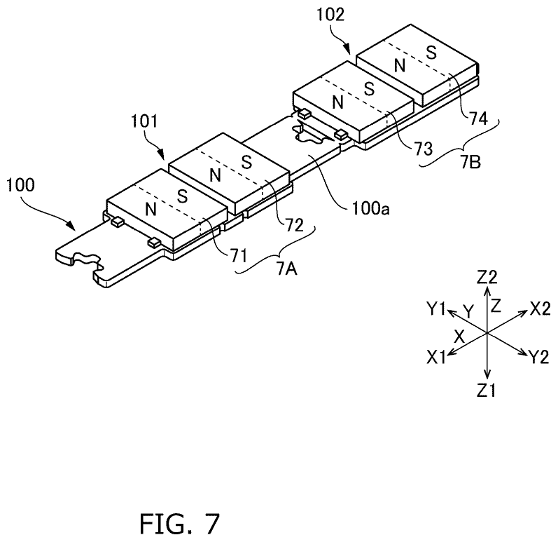

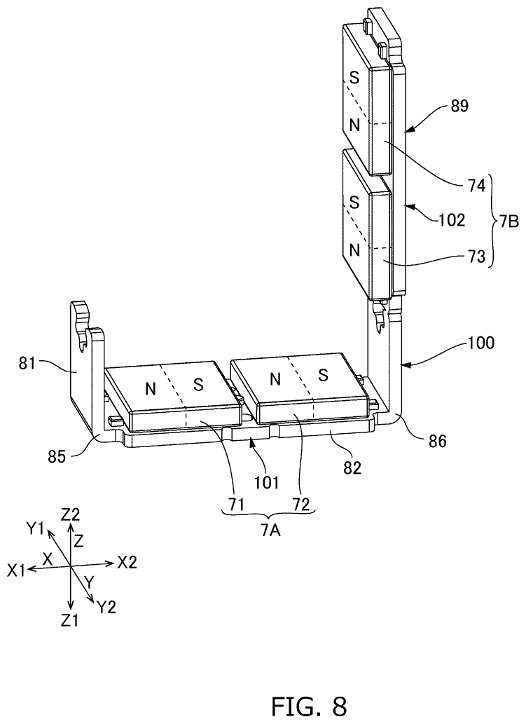

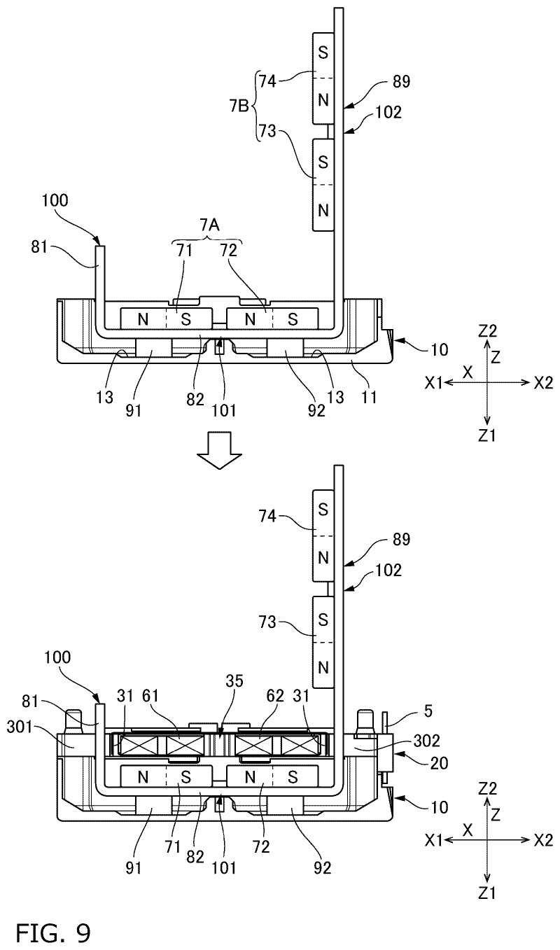

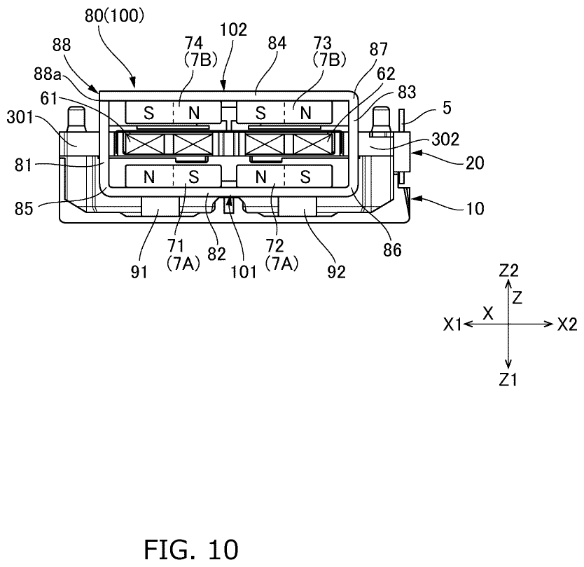

An assembly method of the actuator 1 will be described below. FIG. 6 is a flow chart showing an assembly method of the actuator 1. As shown in FIG. 6, the assembly method of the actuator 1 includes a magnet fixing step “ST1”, a magnet magnetizing step “ST2”, a yoke preparation step “STY”, a yoke arrangement step “ST4”, a yoke bending step “ST5”, a fixed part forming step “ST6” and a subsequent step “ST7” in this order. FIG. 7 is an explanatory view showing a magnet fixing step “ST1” and a magnet magnetizing step “ST2”. FIG. 8 is an explanatory view showing a yoke preparation step “STY”. FIG. 9 is an explanatory view showing a yoke arrangement step “ST4”. FIG. 10 is an explanatory view showing a yoke bending step “ST5” and a fixed part forming step “ST6”.

In the magnet fixing step “ST1”, as shown in FIG. 7, one side magnet 7A is fixed at a first fixing position 101 which is set on a face 100a on one side of a yoke member 100 in a flat plate shape having a constant thickness, and the other side magnet 7B is fixed to a second fixing position 102 which is set on the “X2” direction side with respect to the first fixing position 101. Specifically, a first magnet 71 and a second magnet 72 are fixed at the first fixing position 101 from the “X1” direction side toward the “X2” direction side in this order. Further, a third magnet 73 and a fourth magnet 74 are fixed at the second fixing position 102 from the “X1” direction side toward the “X2” direction side in this order. Therefore, the first magnet 71, the second magnet 72, the third magnet 73 and the fourth magnet 74 are arranged on the face 100a of the yoke member 100 from the “X1” direction side toward the “X2” direction side in this order. In this embodiment, an unmagnetized magnet is used as the first magnet 71, the second magnet 72, the third magnet 73 and the fourth magnet 74.

In the magnet magnetizing step “ST2”, the first magnet 71, the second magnet 72, the third magnet 73 and the fourth magnet 74 are magnetized so that an “S”-pole and an “N”-pole are alternately disposed in the “X”-axis direction. As a result, the first magnet 71 and the second magnet 72 are disposed on the yoke member 100 so that different poles face each other in the “X”-axis direction. Further, the second magnet 72 and the third magnet 73 are disposed on the yoke member 100 so that different poles face each other in the “X”-axis direction. In addition, the third magnet 73 and the fourth magnet 74 are disposed on the yoke member 100 so that different poles face each other in the “X”-axis direction. In this embodiment, in the example shown in FIG. 7, each of the magnets 71 through 74 is magnetized so that an “N”-pole is located on the “X1” direction side and an “S”-pole is located on the “X2” direction side. However, the magnet may be magnetized so that an “S”-pole is located on the “X1” direction side and an “N”-pole is located on the “X2” direction side.

In the yoke preparation step “STY”, as shown in FIG. 8, the yoke member 100 is bent at two positions on both sides with respect to the first fixing position 101. In other words, in the yoke preparation step “ST3”, the yoke member 100 is bent on one side in the “X”-axis direction with respect to the first fixing position 101 where the one side magnet 7A is fixed, and the yoke member 100 is formed with the first bent portion 85 and the first yoke portion 81. Further, in the yoke preparation step “STY”, the yoke member 100 is bent on the other side in the “X”-axis direction with respect to the first fixing position 101, and the yoke member 100 is formed with the second bent portion 86 and the second yoke portion 82 and, in addition, formed with an extended yoke portion 89 which is extended in a straight shape in the first axis direction “Z”. The extended yoke portion 89 is a portion provided with the second fixing position 102. The extended yoke portion 89 is fixed with the other side magnet 7B.

In the yoke arrangement step “ST4”, as shown in the upper stage in FIG. 9, a first connection body 91 and a second connection body 92 are respectively disposed in two recessed parts 13 of a first end plate part 11 of a first support member 10, and the first connection body 91 and the second connection body 92 are connected with the first support member 10. Further, the first connection body 91 and the second connection body 92 support the second yoke portion 82 of the yoke member 100. After that, as shown in the lower stage in FIG. 9, a coil holder 30 is overlapped with the first support member 10 from the “Z2” direction side. When the coil holder 30 is to be overlapped with the first support member 10, the first yoke portion 81 of the yoke member 100 is penetrated through a cut-out part 301 which is located on the “X1” direction side with respect to a coil holding part 35. Further, the extended yoke portion 89 of the yoke member 100 is penetrated through an opening part 302 located on the “X2” direction side with respect to the coil holding part 35. In other words, in the yoke arrangement step “ST4”, the first bent portion 85, the second yoke portion 82 and the second bent portion 86 of the yoke member 100 are disposed on the “Z1” direction side with respect to the coil holding part 35, and the first yoke portion 81 is located on the “X1” direction side with respect to the coil holding part 35, and the extended yoke portion 89 is located on the “X2” direction side with respect to the coil holding part 35.

In this embodiment, in the coil holder 30, a width dimension “L” (see FIG. 4) in the “X”-axis direction of the opening part 302 which is provided on the “X2” direction side with respect to the coil holding part 35 is larger than a yoke thickness dimension “Y” (see FIG. 2) of the yoke member 100 and a magnet thickness dimension “M” (see FIG. 2) of the other side magnet 7B (third magnet 73 and the fourth magnet 74). Therefore, the extended yoke portion 89 of the yoke member 100 can be penetrated through the opening part 302 of the coil holder 30.

In the yoke bending step “ST5”, the extended yoke portion 89 is bent at a position between the second fixing position 102 where the other side magnet 7B is fixed and the second bent portion 86 and on the other side in the first axis direction with respect to the coil holding part 35. As a result, as shown in FIG. 10, the yoke member 100 is formed with the third yoke portion 83, the third bent portion 87 and the fourth yoke portion 84, and the fourth yoke portion 84 is extended in the “X”-axis direction. When the fourth yoke portion 84 is extended in the “X”-axis direction, the one side magnet 7A fixed to the second yoke portion 82 and the other side magnet 7B fixed to the fourth yoke portion 84 are disposed so that different poles face each other with the coil interposed therebetween in the “Z”-axis direction. In other words, the first magnet 71 fixed to the second yoke portion 82 and the fourth magnet 74 fixed to the fourth yoke portion 84 are disposed so that different poles face each other with the first coil 61 interposed therebetween in the “Z”-axis direction. Further, the second magnet 72 fixed to the second yoke portion 82 and the third magnet 73 fixed to the fourth yoke portion 84 are disposed so that different poles face each other with the second coil 62 interposed therebetween in the “Z”-axis direction.

In the fixed part forming step “ST6”, an end portion on the “X1” direction side of the fourth yoke portion 84 and an end portion on the other side in the first axis direction of the first yoke portion 81 are fixed to each other. In this embodiment, an end portion on the “X1” direction side of the fourth yoke portion 84 and an end portion on the other side in the first axis direction of the first yoke portion 81 are welded to each other. Therefore, the fixed part 88 is formed with a welded mark 88a. In this manner, the yoke 80 is completed. The yoke 80 is structured in a state that the yoke 80 surrounds the coil holding part 35 when viewed in the “Y”-axis direction.

In the subsequent step “ST7”, a third connection body 93 and a fourth connection body 94 are arranged on the “Z2” direction side of the fourth yoke portion 84 of the yoke 80, and a second support member 20 is overlapped with the coil holder 30 from the “Z2” direction side. As a result, the yoke 80 and the second support member 20 are connected with each other in a state that the third connection body 93 and the fourth connection body 94 are respectively located in two recessed parts 23 of a second end plate part 21 of the second support member 20. When the third connection body 93 and the fourth connection body 94 connect the yoke 80 with the second support member 20, the movable body 3 and the support body 2 are relatively connected with each other so as to be capable of moving in the “X”-axis direction by the first connection body 91, the second connection body 92, the third connection body 93 and the fourth connection body 94.

### Operations and Effects

In the actuator 1 in this embodiment, the yoke 80 which surrounds the coil holding part 35 holding the coil 6 is one member provided with three bent portions 85, 86 and 87 and one fixed part 88. Therefore, in comparison with a case that the yoke 80 is structured of two yoke members 100 which are combined with each other, the number of the components can be reduced. Further, an welding operation which is fastening work when the yoke 80 is to be assembled is performed on only one fixed part 88. Therefore, in comparison with a case that fastening work is performed at a plurality of positions, the actuator 1 is easily assembled.

In this embodiment, the support body 2 includes, as the coil 6, the first coil 61 and the second coil 62 which is arranged on the “X2” direction side with respect to the first coil 61. The movable body 3 includes, as the one side magnet 7A, the first magnet 71 facing the first coil 61 and the second magnet 72 facing the second coil 62 on the “X2” direction side with respect to the first magnet 71. Further, the movable body 3 includes, as the other side magnet 7B, the third magnet 73 facing the second coil 62 and the fourth magnet 74 facing the first coil 61 on the “X1” direction side with respect to the second magnet 72. The first magnet 71 and the fourth magnet 74 are disposed so that different poles face each other with the first coil 61 interposed therebetween. The third magnet 73 and the second magnet 72 are disposed so that different poles face each other with the second coil 62 interposed therebetween. As a result, a plurality of a pair of a magnetic drive circuit which is structured of the coil 6, the one side magnet 7A and the other side magnet 7B is provided and thus, thrust of the magnetic drive mechanism 4 by which the movable body 3 and the support body 2 are relatively moved can be easily increased.

Further, the assembly method of the actuator 1 in this embodiment includes:
the magnet fixing step “ST1” in which one side magnet 7A is fixed at a first fixing position 101 which is set on one face 100a of a yoke member 100 in a flat plate shape and the other side magnet 7B is fixed at a second fixing position 102 which is set on the “X2” direction side with respect to the first fixing position 101;
the yoke preparation step “STY” in which the yoke member 100 is bent on the “X1” direction side with respect to the first fixing position 101 where the one side magnet 7A is fixed to form a first bent portion 85 and a first yoke portion 81 in the yoke member 100, and
the yoke member 100 is bent on the “X2” direction side with respect to the first fixing position 101 to form in the yoke member 100 with a second bent portion 86, a second yoke portion 82 and an extended yoke portion 89 in which a third yoke portion 83 and a fourth yoke portion 84 are continuously extended in the first axis direction in a straight shape;
the yoke arrangement step “ST4” in which the first bent portion 85, the second yoke portion 82 and the second bent portion 86 are disposed on the “Z1” direction side with respect to the coil holding part 35 to locate the first yoke portion 81 on the “X1” direction side with respect to the coil holding part 35 and locate the extended yoke portion 89 on the “X2” direction side with respect to the coil holding part 35;
the yoke bending step “ST5” in which the extended yoke portion 89 is bent on the other side in the first axis direction with respect to the coil holding part 35 between the second fixing position 102 where the other side magnet 7B is fixed and the second bent portion 86 to form in the yoke member 100 with the third yoke portion 83, the third bent portion 87 and the fourth yoke portion 84, and the fourth yoke portion 84 is extended in the “X”-axis direction; and
the fixed part forming step “ST6” in which an end portion on the “X1” direction side of the fourth yoke portion 84 and an end portion on the other side in the first axis direction of the first yoke portion 81 are fixed to each other.

According to the above-mentioned assembly method, first, the yoke member 100 in a flat plate shape to which the one side magnet 7A and the other side magnet 7B are fixed is bent twice to form the first bent portion 85, the second yoke portion 82, the second bent portion 86 and the extended yoke portion 89. Next, the first bent portion 85, the second yoke portion 82 and the second bent portion 86 are disposed on the “Z1” direction side with respect to the coil holding part 35, and the first yoke portion 81 is located on the “X1” direction side with respect to the coil holding part 35, and the extended yoke portion 89 is located on the “X2” direction side with respect to the coil holding part 35. After that, the extended yoke portion 89 is bent on the “Z2” direction side with respect to the coil holding part 35 to form the third yoke portion 83, the third bent portion 87 and the fourth yoke portion 84, and the fourth yoke portion 84 is extended in the “X”-axis direction. After that, an end portion on the “X1” direction side of the fourth yoke portion 84 and an end portion on the “Z2” direction side of the first yoke portion 81 are fixed to each other. Therefore, the one side magnet 7A and the other side magnet 7B which are fixed to the yoke member 100 in a flat plate shape are easily located on both sides with respect to the coil 6 in the first axis direction. Further, the coil holding part 35 which holds the coil 6 is easily surrounded by the yoke 80,

Further, in this embodiment, in the magnet fixing step “ST1”, an unmagnetized magnet is used as the one side magnet 7A and the other side magnet 7B, and a magnet magnetizing step “ST2” in which the one side magnet 7A and the other side magnet 7B are magnetized so that an “N”-pole and an “S”-pole are alternately arranged in the “X”-axis direction is provided between the magnet fixing step “ST1” and the yoke preparation step “STY”. More specifically, in the magnet fixing step “ST1”, an unmagnetized magnet is used as the first magnet 71, the second magnet 72, the third magnet 73 and the fourth magnet 74, and the first magnet 71, the second magnet 72, the third magnet 73 and the fourth magnet 74 are fixed to the yoke member 100 from the “X1” direction side toward the other side in this order. In the magnet magnetizing step “ST2” between the magnet fixing step “ST1” and the yoke preparation step “ST3”, the first magnet 71, the second magnet 72, the third magnet 73 and the fourth magnet 74 are magnetized so that an “S”-pole and an “N”-pole are alternately arranged in the “X”-axis direction. Therefore, in comparison with a case that the magnets 71 through 74 arranged in the “X”-axis direction are magnetized so that the same poles face each other, magnetizing work is easily performed. Further, when the yoke member 100 is bent at the three bent portions 85, 86 and 87, the first magnet 71 and the fourth magnet 74 are disposed so that different poles face each other with the first coil 61 interposed therebetween, and the second magnet 72 and the third magnet 73 are disposed so that different poles face each other with the second coil 62 interposed therebetween.

### Other Embodiments

In the fixed part forming step “ST6”, an end portion on the “Z2” direction side of the first yoke portion 81 of the yoke 80 and an end portion on the “X1” direction side of the fourth yoke portion 84 may be connected with each other by caulking. In other words, it may be structured that the actuator 1 is provided with a caulking mark 88a in a fixed part 88 of an end portion on the “Z2” direction side of the first yoke portion 81 of the yoke 80 and an end portion on the “X1” direction side of the fourth yoke portion 84.

Further, in the magnet fixing step “ST1”, it may be structured that a magnet which is polarized and magnetized in the “X”-axis direction is used as the one side magnet 7A and the other side magnet 7B, and magnets adjacent to each other in the “X”-axis direction are arranged so that different poles face each other.

More specifically, in the magnet fixing step “ST1”, a magnet which is polarized and magnetized in the “X”-axis direction is used as the first magnet 71, the second magnet 72, the third magnet 73 and the fourth magnet 74, and the first magnet 71, the second magnet 72, the third magnet 73 and the fourth magnet 74 are arranged in this order from the “X1” direction side toward the other side so that different poles face each other in magnets adjacent to each other in the “X”-axis direction. According to this structure, a situation can be avoided that adjacent magnets arranged in the “X”-axis direction repel each other and thereby, the magnets are difficult to be fixed to the yoke member 100. Further, when the yoke member 100 is bent at three bent portions 85, 86 and 87, the first magnet 71 and the fourth magnet 74 are disposed so that different poles face each other with the first coil 61 interposed therebetween, and the second magnet 72 and the third magnet 73 are disposed so that different poles face each other with the second coil 62 interposed therebetween.

In this embodiment, in a case that magnetized magnets 71 through 74 are used in the magnet fixing step “ST1”, an assembly method of the actuator 1 includes the magnet fixing step “ST1”, the yoke preparation step “STY”, the yoke arrangement step “ST4”, the yoke bending step “ST5”, the fixed part forming step “ST6” and the subsequent step “ST7” in this order. In other words, the magnet magnetizing step “ST2” is omitted in the flow chart shown in FIG. 6.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An actuator comprising:
in a case that two directions perpendicular to each other are defined as a first axis direction and a second axis direction,
a support body comprising:
a coil whose opening is directed in the first axis direction;
a coil holder having a coil holding part which holds the coil;
a first support member which supports the coil holder from one side in the first axis direction; and
a second support member which supports the coil holder from an other side in the first axis direction;
a movable body comprising:
one side magnet which faces the coil on one side in the first axis direction;
an other side magnet which faces the coil on the other side in the first axis direction; and
a yoke to which the one side magnet and the other side magnet are fixed;
a connection body which relatively movably connects the first support member and the movable body in the second axis direction between the first support member and the movable body; and
a magnetic drive mechanism comprising the one side magnet, the other side magnet and the coil and relatively moving the movable body and the support body in the second axis direction;
wherein the yoke comprises:
a first yoke portion which is extended in the first axis direction on one side in the second axis direction with respect to the coil holding part;
a second yoke portion which is extended in the second axis direction on one side in the first axis direction with respect to the coil holding part and is fixed with the one side magnet;
a third yoke portion which is extended in the first axis direction on the other side in the second axis direction with respect to the coil holding part;
a fourth yoke portion which is extended in the second axis direction on the other side in the first axis direction with respect to the coil holding part and is fixed with the other side magnet;
a first bent portion which continuously connects the first yoke portion with the second yoke portion;
a second bent portion which continuously connects the second yoke portion with the third yoke portion;
a third bent portion which continuously connects the third yoke portion with the fourth yoke portion; and
a fixed part in which an end portion on one side in the second axis direction of the fourth yoke portion and an end portion on the other side in the first axis direction of the first yoke portion are fixed to each other;
the one side magnet is polarized and magnetized in the second axis direction, and the other side magnet is polarized and magnetized in the second axis direction; and
the one side magnet and the other side magnet are disposed so that different poles face each other with the coil interposed therebetween.

2. The actuator according to claim 1, wherein the fixed part comprises a welded mark.

3. The actuator according to claim 1, wherein the fixed part comprises a caulking mark.

4. The actuator according to claim 1, wherein
the coil holder comprises an opening part which penetrates in the first axis direction on the other side in the second axis direction with respect to the coil holding part,
the third yoke portion penetrates through the opening part,
thicknesses of the third yoke portion and the fourth yoke portion are same as each other, and
a width dimension in the second axis direction of the opening part is larger than a total dimension of a yoke thickness dimension of the fourth yoke portion and a magnet thickness dimension of the other side magnet.

5. The actuator according to claim 1, wherein
the support body comprises, as the coil, a first coil and a second coil which is disposed on the other side in the second axis direction with respect to the first coil,
the movable body comprises:
as the one side magnet, a first magnet facing the first coil and a second magnet which faces the second coil on the other side in the second axis direction with respect to the first magnet; and
as the other side magnet, a third magnet facing the second coil and a fourth magnet which faces the first coil on one side in the second axis direction with respect to the third magnet,
the first magnet and the fourth magnet are disposed so that different poles face each other with the first coil interposed therebetween, and
the third magnet and the second magnet are disposed so that different poles face each other with the second coil interposed therebetween.

6. An assembly method of the actuator defined in claim 1, comprising:
a magnet fixing step in which the one side magnet is fixed to a first fixing position which is set on one face of a yoke member formed in a flat plate shape, and the other side magnet is fixed to a second fixing position which is set on the other side in the second axis direction with respect to the first fixing position;
a yoke preparation step in which:
the yoke member is bent on one side in the second axis direction with respect to the first fixing position where the one side magnet is fixed to form the first bent portion and the first yoke portion in the yoke member; and
the yoke member is bent on the other side in the second axis direction with respect to the first fixing position to form in the yoke member with the second bent portion, the second yoke portion and an extended yoke portion which is structured of the third yoke portion and the fourth yoke portion which are continuously extended in a straight shape in the first axis direction,
a yoke arrangement step in which the first bent portion, the second yoke portion and the second bent portion are disposed on one side in the first axis direction with respect to the coil holding part and thereby, the first yoke portion is located on one side in the second axis direction with respect to the coil holding part, and the extended yoke portion is located on the other side in the second axis direction with respect to the coil holding part,
a yoke bending step in which the extended yoke portion is bent on the other side in the first axis direction with respect to the coil holding part between the second fixing position where the other side magnet is fixed and the second bent portion to form the third yoke portion, the third bent portion and the fourth yoke portion in the yoke member, and the fourth yoke portion is extended in the second axis direction, and
a fixed part forming step in which an end portion on one side in the second axis direction of the fourth yoke portion and an end portion on the other side in the first axis direction of the first yoke portion are fixed to each other.

7. The assembly method of the actuator according to claim 6, wherein in the fixed part forming step, the fourth yoke portion and the first yoke portion are welded to each other.

8. The assembly method of the actuator according to claim 6, wherein in the fixed part forming step, the fourth yoke portion and the first yoke portion are caulked with each other.

9. The assembly method of the actuator according to claim 6, wherein
the coil holder comprises an opening part penetrating in the first axis direction on the other side in the second axis direction with respect to the coil holding part,
in the yoke arrangement step, the extended yoke portion is penetrated through the opening part to locate the extended yoke portion on the other side in the second axis direction with respect to the coil holding part, and
a width dimension of the opening part in the second axis direction is larger than a total dimension of a thickness dimension of the extended yoke portion and a thickness dimension of the other side magnet.

10. The assembly method of the actuator according to claim 6, wherein
in the magnet fixing step, a magnet which is polarized and magnetized in the second axis direction is used as the one side magnet and the other side magnet, and
magnets adjacent to each other in the second axis direction are arranged so that different poles face each other.

11. The assembly method of the actuator according to claim 6, wherein in the actuator,
the support body comprises, as the coil, a first coil and a second coil which is disposed on the other side in the second axis direction with respect to the first coil,
the movable body comprises:
as the one side magnet, a first magnet facing the first coil and a second magnet which faces the second coil on the other side in the second axis direction with respect to the first magnet; and
as the other side magnet, a third magnet facing the second coil and a fourth magnet which faces the first coil on one side in the second axis direction with respect to the third magnet,
the first magnet and the fourth magnet are disposed so that different poles face each other with the first coil interposed therebetween,
the second magnet and the third magnet are disposed so that different poles face each other with the second coil interposed therebetween,
in the magnet fixing step, a magnet which is polarized and magnetized in the second axis direction is used as the first magnet, the second magnet, the third magnet and the fourth magnet, and the first magnet, the second magnet, the third magnet and the fourth magnet are arranged from one side in the second axis direction toward the other side in this order so that different poles face each other in magnets adjacent to each other in the second axis direction.

12. The assembly method of the actuator according to claim 6, wherein
in the magnet fixing step, an unmagnetized magnet is used as the one side magnet and the other side magnet, and
a magnet magnetizing step is provided between the magnet fixing step and the yoke preparation step, and
in the magnet magnetizing step, the one side magnet and the other side magnet are magnetized so that an “S”-pole and an “N”-pole are alternately arranged in the second axis direction.

13. The assembly method of the actuator according to claim 6, wherein in the actuator,
the support body comprises, as the coil, a first coil and a second coil which is disposed on the other side in the second axis direction with respect to the first coil,
the movable body comprises:
as the one side magnet, a first magnet facing the first coil and a second magnet which faces the second coil on the other side in the second axis direction with respect to the first magnet; and
as the other side magnet, a third magnet facing the second coil and a fourth magnet which faces the first coil on one side in the second axis direction with respect to the third magnet,
the first magnet and the fourth magnet are disposed so that different poles face each other with the first coil interposed therebetween,
the second magnet and the third magnet are disposed so that different poles face each other with the second coil interposed therebetween,
in the magnet fixing step, an unmagnetized magnet is used as the first magnet, the second magnet, the third magnet and the fourth magnet, and the first magnet, the second magnet, the third magnet and the fourth magnet are fixed to the yoke member from one side in the second axis direction toward the other side in this order,
a magnet magnetizing step is provided between the magnet fixing step and the yoke preparation step, and
in the magnet magnetizing step, the first magnet, the second magnet, the third magnet and the fourth magnet are magnetized so that an “S”-pole and an “N”-pole are alternately arranged in the second axis direction.
